(19) United States
(12) Patent Application Publication
(10) Pub. No.: US 2010/0107114 A1
(43) Pub. Date: Apr. 29, 2010

(54) IN CONTEXT WEB PAGE LOCALIZATION

(76) Inventor: Slawomir ZACHCIAL, Grenoble (IL)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/259,617

(22) Filed: Oct. 28, 2008

(51) Int. Cl. G06F 3/048

(52) U.S. Cl. 715/780

(57) ABSTRACT

According to one embodiment, in context web page localization is provided. A web page is displayed. A displayed element of the web page is selected. A localization value for the selected element is entered. The web page is re-displayed showing the entered localization value instead of an original value associated with the element. The localization value is received by an application application, which displays the web page, receives the entered localization value and re-displays the web page.

### BACKGROUND

Web pages enable application users to see information displayed by an application. Web pages may also provide links or input fields that enable application users to request additional or different information. Various elements associated with a web page enable associating the displayed information with the web page. For example, one element may be used to display the title of the web page. Another element may be used to display a word, a sentence, or a paragraph on the web page. Other examples of elements include, but are not limited to, a link and an image.

Frequently, there is a desire to make an application available to people who speak many different languages. In order to avoid designing a different web page for each language, the web page's source code (referred to herein as “web page source”) refers to keys which map to values. When a web page is rendered for display, the keys in the web page source, in conjunction with the specified language, are used to retrieve the appropriate values that are inserted into the web page. For example, if the key is for the web page's title and the specified language is French, then the French version of the web page's title is retrieved and inserted instead of the English version of the web page's title.

### BRIEF DESCRIPTION OF THE DRAWINGS

The accompanying drawings, which are incorporated in and form a part of this Description of Embodiments, illustrate various embodiments of the present invention and, together with the description, serve to explain principles discussed below:

FIG. 1 depicts a data flow of in context web page localization, according to one embodiment.

FIG. 2 depicts a block diagram of an apparatus for in context web page localization, according to one embodiment.

FIGS. 3 and 4 depict block diagrams of methods for in context web page localization, according to one various embodiment.

The drawings referred to in this Brief Description should not be understood as being drawn to scale unless specifically noted.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, localizations and equivalents, which may be included within the spirit and scope the various embodiments as defined by the appended claims. Furthermore, in the following Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “receiving,” “selecting,” “displaying,” “localizing,” “re-displaying,” “accessing,” “enabling,” “detecting,” “using,” “localizing,” or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. Some embodiments of the subject matter are also well suited to the use of other computer systems such as, for example, optical and virtual computers.

### Introduction of Discussion

Conventionally, translators from various countries are hired to translate the values associated with a web page's elements. Typically, the translators are not technical people. The translators are usually provided a list of keys for an application's web pages and the corresponding values in English, which the translators translate into their respective languages. Since the translator sees the values outside of the context that they will be used in, the translators have no information on how the values will be displayed on the web page, how much space is available for displaying the values, how the values are related to each other on the same page or between pages.

The translations are provided to the application development team, which updates a repository with the translations. An application test team then executes the application to see whether the translations make sense in the context of the application's displayed web pages (referred to herein as “in context”). If the translations do not make sense when viewed in context, the translators are provided feedback and the cycle of the translators translating values, the application development team updating the repository and the application test team executing the application begins again. This cycle continues until the values are translated in a way that makes sense when viewed in the context of the displayed web pages. The process of translating values, such as text, is also commonly referred to as “localization” and the values that are translated are commonly referred to as “localized values” or as “localization values.”

According to one embodiment, a method of and a system for in context web page localization that enables a non-technical user to localize a value associated with a displayed web page's element and to re-display the web page after the value has been localized is provided. Thus, various embodiments provide for reducing the number of iterations in the cycle of translating values, updating the repository and re-executing the application.

### Web Page

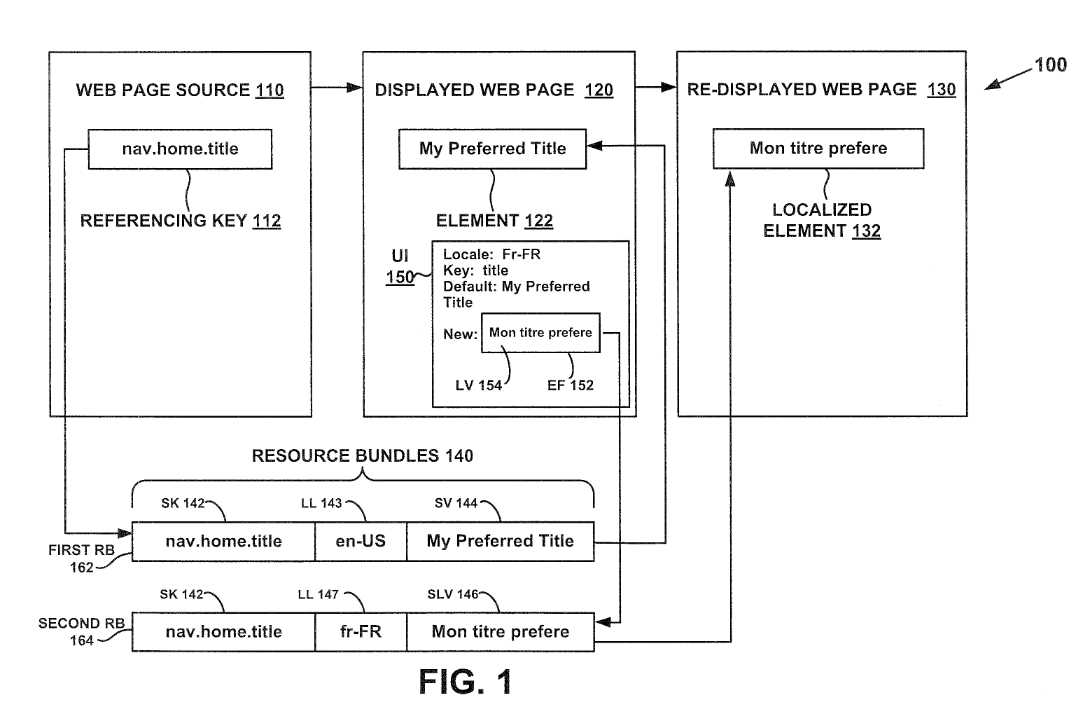

FIG. 1 depicts a data flow of in context web page localization, according to one embodiment. The blocks that represent features in FIG. 1 can be arranged differently than as illustrated, and can implement additional or fewer features than what are described herein. Further, the features represented by the blocks in FIG. 1 can be combined in various ways. The features depicted in the data flow 100 can be implemented using software, hardware, firmware, or a combination thereof.

FIG. 1 depicts a web page source 110, a displayed web page 120, a re-displayed web page 130, stored resource bundles 140, and a user interface 150. The stored resource bundles 140 include a first resource bundle 162 and a second resource bundle 164. The first and second resource bundles 162, 164 respectively include stored keys 142, 145 language-locals 143, 147 and stored values 144, 146. The first resource bundle 162 pertains to English in the United States. Therefore the language-local 143 for the first resource bundle 162 is en-US. The second resource bundle 164 pertains to French in France. Therefore, the language-local 147 for the second resource bundle 164 is fr-FR. Both of the stored keys 142, 145 associated with the resource bundles 162, 164 include the same key value “nav.home.title.” According to one embodiment, the resource bundles 140 are stored in persistent memory, such as a database or a file. The web page source 110 includes a key 112 (also referred to herein as “a referencing key”) that references the stored keys 142, 145. The user interface 150 includes a field 152 for entering a localization value 154 for an original value 144. The stored localized value 146 reflects that the original value 144 has been localized using the localization value 154 entered into the entry field 152. The displayed web page 120 includes a localized element 132. The localized element 132 reflects the stored localized value 146.

A web page's source includes keys that are used to determine which values to associate with a displayed version of the web page (referred to herein as “displayed web page”). For example, the web page source 110 includes a referencing key 112 for the web page's title, such as nav.home.title. When the web page is being rendered, the referencing key 112 for the title, in conjunction with the specified language are used to determine which value 144 for the title to insert into the web page 120. More specifically, if the specified language is French, then the French title is inserted into the web page 120. If the specified language option is English, then the English title is inserted into the web page 120. The web page 120 is displayed with the title inserted into it in the form of what is referred to herein as an element 122.

According to one embodiment, a user can localize a value associated with a displayed web page's element and cause the web page to be re-displayed after the value has been localized. For example, when the user session associated with the executing application is switched to a special mode (also referred to herein as “in-context-web-page-localization-mode”) that allows a value 144 associated with a displayed web page 120's element 122 to be localized. More specifically, assume that the user wants to localize the web page's title 122 “My Preferred Title,” to “Mon titre prefere.” The user can cause a user interface 150 to be displayed by causing the cursor to move in the vicinity of the displayed title 122. The user can localize the title 122 by entering a localization value 154 for the title, such as “Mon titre prefere,” into an entry field 152 the user interface 150. The localized element 132 associated with the re-displayed web page 130 reflects that a localized value 154 has been entered for the stored value 144, associated with the English version. The entered localized value 154, for the French translation “Mon titre prefere,” is associated with the original value 144, for example, by storing the entered localized value 154 into stored localized value 146. The web page 120 can be re-displayed with the new title, resulting in re-displayed web page 130, thus allowing the user to see the localized element 132 with the new title, “Mon titre prefere,” stored at 146 in the context of the re-displayed web page 130.

The displayed web 120, the user interface 150, and the re-displayed web page 130 are associated with the same application, according to one embodiment. Thus, the user can localize the title repeatedly using various embodiments without involving the time consuming process of requiring an application team to update a repository and to test values associated with the repository. For example, the user could cause the cursor to move over the localized element 132 associated with the re-displayed web page 130 causing the user interface 150 to be displayed again. The user could enter another localization value for the title, such as “Mon titre prefere 2,” into the entry field 152 resulting in “Mon titre prefere 2” replacing “Mon titre prefere” at storage location 146. According to one embodiment, the user can localize an original value 144 repeatedly during the same user session of the application without exiting the application.

### Keys, Language-Local, and Values

As already stated, web page source 110 include keys 112 that are used to insert values into web pages 120, 130 when the web pages 120, 130 are displayed. Examples of values include but are not limited to text, an image, HTML attribute values, and links. Text may be a word, a phrase, a sentence, or a paragraph, among other things.

Values may be visible or invisible to an application user. For example, a title, a sentence or a paragraph are examples of values that are displayed when the application is executed in normal mode and therefore would be visible to an application user.

Nav.home, nav.home.title, nav.home.href, logo.alt, and logo.href are examples of keys that can be used for associating invisible values with a web page. Although the invisible values may be associated with a web page using an appropriate key, the values would not be visible to an application user when the application is executed in normal mode. Nav.home, nav.home.title, and nav.home.href are examples of three keys that are associated with a link. Nav.home is a key to a link's text. Nav.home.title is a key to a link's title. Nav.home.href is a key to a link's href attributes. Logo.alt and logo.href are examples of keys that are associated with an image. Logo.alt is a key to the alternative text for a logo. Logo.href is a key to the universal resource locator (URL) associated with a logo.

The naming convention of keys can be used to bundle keys together. For example, Nav.home, nav.home.title and nav.home.href all begin with nav.home. Therefore, an element, such as “home,” could be displayed on a web page in in-context-web-page-localization-mode. A user interface can be displayed that enables localization of any one or more of the keys associated with a group, such as nav.home, nav.home.title and nav.home.href. Similar processing can be performed for logo.alt and logo.href or any other group of keys.

A resource bundle is a set of key value pairs for a given language-local. Typically, there is a set of resource bundles for each key associated with a web page for each language-local. For example, if a web page references keys A and B, and there are three language-locals, then there would be three sets of resource bundles for the three language-locals each containing two resource bundles for the two keys A and B with translations for the values associated with the keys A and B. The resource bundles can be stored in a file that is commonly known as a repository or a resource bundle file.

### Elements

Elements are displayed on a web page. An element, which corresponds to a visible value, displays a value to an application user. For example, a title, such as “Mon titre prefere,” or “My Preferred Title,” that appears on a displayed web page 120, 130 is an example of an element that corresponds to a visible value 144, 146.

An element, which corresponds to an invisible value, displays an element that a non-technical user, such as a translator, can use to cause a user interface to appear in order to localize the value that corresponds to that element. For example, assume that a translator wishes to localize an invisible value, such as the alternative text that is associated with a logo image, which is associated with the logo.alt key. An element such as “logo. %” may be displayed in the vicinity of the logo image on the displayed web page when the application for the displayed web page is executed in in-context-web-page-localization-mode. The translator can move the mouse causing the cursor to move near the displayed “logo. %” element, which results in a user interface being displayed that enables the translator to localize an original value associated with the logo.alt key. According to one embodiment, an element that corresponds to an invisible value is displayed when the application for the web page is executed in in-context-web-page-localization-mode, however, the element that corresponds to an invisible value does not appear when the application is executed in normal mode. The element that corresponds to the invisible value provides a handle, according to one embodiment, so that the invisible value can be localized.

According to one embodiment, more than one element can be displayed on a displayed web page. Various embodiments can be used for seeing how the plurality of elements relate to each other in the context of one or more displayed web pages associated with the application for the displayed web page.

### Centralized Localization Memory

A pseudo translation can be obtained from a centralized localization memory, according to one embodiment. For example, assume that this is the first time that a web page is going to be rendered in French. Values for the various keys associated with the web page have already been provided in English. The first time that a web page is rendered in French, a centralized localization memory can be accessed to obtain an initial pseudo translation from English to French. A translator can proof read the pseudo translation and fine tune the translation using various embodiments described herein. According to one embodiment, the centralized localization memory can be used to provide consistent terms for words that are used across a company. More specifically, the centralized localization memory can be used to provide the correct French translations of various products and terms associated with a company. The centralized localization memory can also be accessed for subsequent translations as well as the initial translation.

### User Interface

A user interface 150 enables a user to enter a localization value 154 for an original value 144 associated with an element 122 displayed on a web page 120. The user interface 150, according to one embodiment, displays the original value, which is depicted as “My Preferred Title” on displayed web page 120, for the selected element 122 and an entry field 152 that enables the user to enter a localization value 154 for the original value 144. The original value may be a “default value.” The entry field 152 will be empty if this is the first time that the selected element 122 has been translated. The user interface 150 may also depict the specified language, such as “fr-FR,” and the key, such as “title,” that corresponds to the original value 144. According to one embodiment, the user interface 150 is a pop-up window that pops up on the displayed web page 120.

According to one embodiment, when a translator causes the cursor to move in proximity to an element 122, a link to the user interface 150 is displayed. The translator can click their mouse on the link in order to display the user interface 150. For example, when the cursor moves in proximity of element 122, the text “translation” may be displayed. The translator can click their mouse on the link by clicking on the text “translation.”

### Apparatus for in Context Web Page Localization

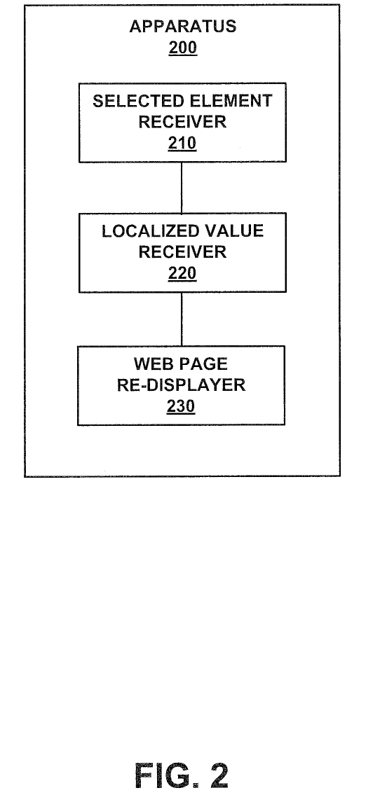

FIG. 2 depicts a block diagram of an apparatus for in context web page localization, according to one embodiment. The blocks that represent features in FIG. 2 can be arranged differently than as illustrated, and can implement additional or fewer features than what are described herein. Further, the features represented by the blocks in FIG. 2 can be combined in various ways. The apparatus 200 can be implemented using software, hardware, firmware, or a combination thereof.

The apparatus includes an in-context-web-page-localization-mode-selected-element-receiver 210 (also referred to herein as “selected-element-receiver”), an in-context-web-page-localization-mode-localized-value-receiver 220 (also referred to herein as “localized-value-receiver”), and an in-context-web-page-localization-mode-web-page-re-displayer 230 (also referred to as “a web-page-re-displayer”). The selected-element-receiver is configured for receiving information describing an element 122, with an associated original value 144, displayed on a web page 120. The localized-value-receiver 220 is configured for receiving a localization value 154 entered into a user interface 150 that is a part of an application that provides the web page 120. The web-page-re-displayer is configured for re-displaying the web page 130 showing the element 132 as a part of associating the localization value 154 with the original value 144. The application for the web page 120, 130 displays the web page 120, receives the entered localization value 154, and re-displays the web page 130. According to one embodiment, the apparatus 200 is associated with the application for the web page 120, 130.

One or more of the displayed web 120, the user interface 150, and the re-displayed web page 130 are associated with the same application. Thus, the user can localize the one or more values repeatedly using various embodiments without involving the time consuming process of requiring an application team to update a repository and to test values associated with the repository.

### Method of in Context Web Page Localization

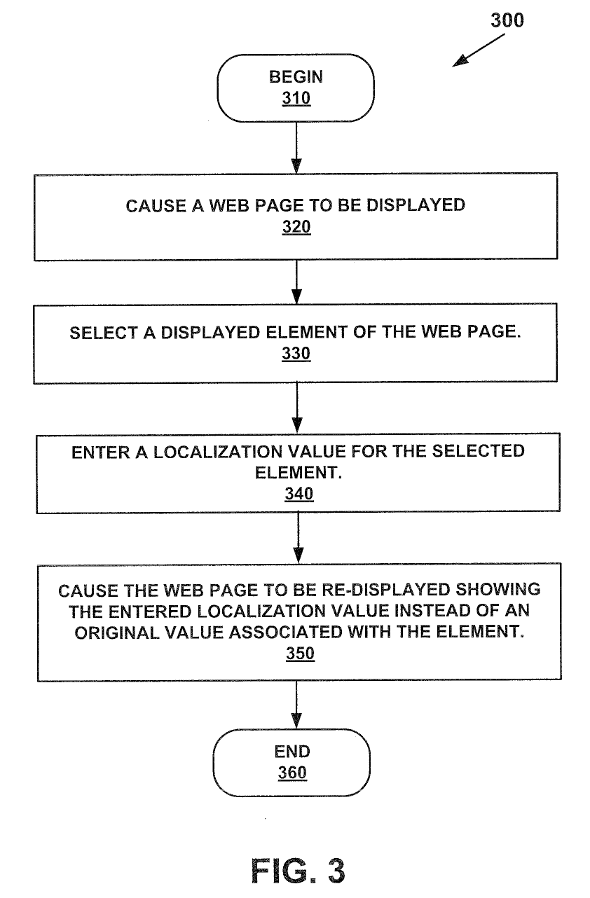

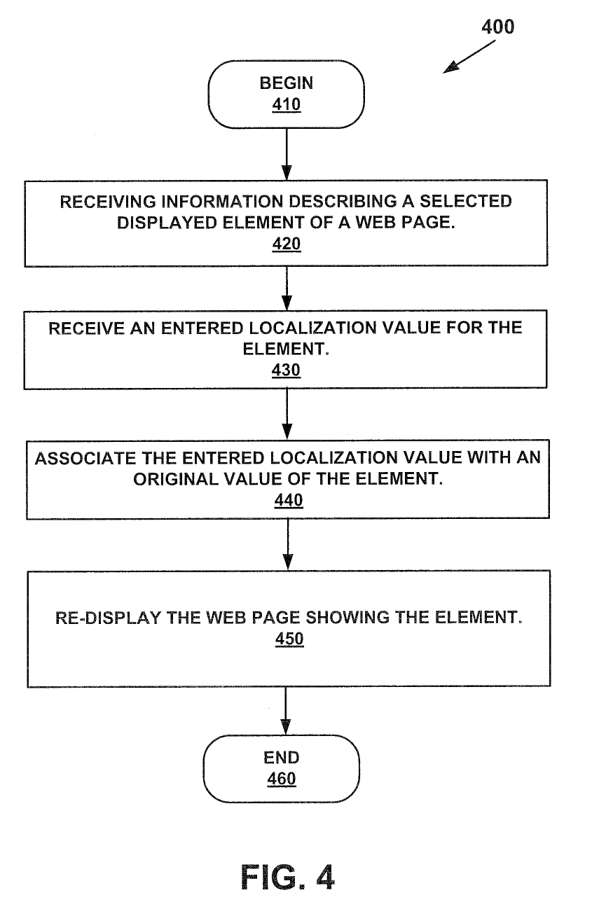

FIGS. 3 and 4 depict flowcharts for a method of in context web page localization, according to various embodiments. Although specific steps are disclosed in flowcharts 300, 400, such steps are exemplary. That is, embodiments of the present invention are well suited to performing various other steps or variations of the steps recited in flowcharts 300, 400. It is appreciated that the steps in flowcharts 300, 400 may be performed in an order different than presented, and that not all of the steps in flowcharts 300, 400 may be performed.

All of, or a portion of, the embodiments described by flowchart 400 can be implemented using computer-usable media and computer-executable instructions which reside, for example, in computer-usable media of a computer system or like device. The computer-usable media can be any kind of memory that instructions can be stored on. Examples of the computer-usable media include but are not limited to a disk, a compact disk (CD), a digital video device (DVD), read only memory (ROM), flash, and so on. As described above, certain processes and steps of embodiments of the present invention are realized, in one embodiment, as a series of instructions (e.g., software program) that reside within computer readable memory of a computer system and are executed by the processor of the computer system. When executed, the instructions cause the computer system to implement the functionality of various embodiments of the present invention as described below.

The description of the flowcharts 300 and 400 for the method of in context web page localization shall refer to FIGS. 1 and 2. Assume that the application, that web page 110, 120, 130 is associated with, is being executed with in-context-web-page-localization-mode and the specified language is French, thus allowing a non-technical user, such as a translator, to see the application's web pages in French and to perform in context web page localization. The web page source 110 includes a referencing key 112, which is nav.home.title. The referencing key 112 in conjunction with the current local, en-US, are used to retrieve a corresponding original value that may be stored as stored value 144. Continuing the example, the referencing key 112 and the stored key 142 are both nav.home.title. The stored key 142, in conjunction with the language-local 143, forms a resource bundle 162 with the stored value 144 “My Preferred Title.” Thus, the referencing key 122 associated with the web page source 110 can be used to retrieve the value 144, “My Preferred Title” from storage.

At 310 and 410, the methods begin.

At 320, a user, such as a translator, causes the web page to be displayed. For example, the translator can execute the application and the web page 120 is rendered resulting in the value 144 “My Preferred Title” being displayed for the title element 122 of the displayed web page 120.

At 330, the user selects the displayed element of the web page. For example, after seeing the original value 144 in the context of the displayed web page 120, assume that the translator wants to translate the title from “My Preferred Title” to “Mon titre prefere.” The title element 122 displays the English translation associated with the original stored value 144 “My Preferred Title.” The translator causes the cursor to move in proximity to the title element 122, thus, selecting the displayed element 122.

At 420, the information describing the selected displayed element of the web page is received. For example, the selected-element-receiver 210 associated with the apparatus 200 depicted on FIG. 2 receives information indicating that the translator selected the displayed title element 122 in order to localize the original value 144, “My Preferred Title,” associated with the title element 122. A user interface 150 is displayed. The key “title,” and the original value 144 “My Preferred Title,” appear on the user interface 150. The entry field 152 will be empty if this is the first time that the title has been translated.

At 340, the user enters a localization value for the selected element. For example, the translator enters a French translation to the original English title “My Preferred Title,” by entering a localization value 154, such as “Mon titre prefere,” into the entry field 152 which corresponds to the selected element 122.

At 430, an entered localization value for the selected element is received. For example, the localized-value-receiver 220 depicted on FIG. 2 receives the entered localization value 154 “Mon titre prefere” from the entry field 152 of the user interface 150.

At 440, the entered localization value is associated with an original value of the element. For example, the French translation 154, “Mon titre prefere,” that was entered into the user interface's 150 entry field 152 is stored in the stored localization value 146 associated with the second resource bundle 164 for the language-local 147, “fr-FR.” Thus, the entered localization value 154 is associated with the original value 144 of the element 122, for example, by storing the entered localization value 154 as the stored localization value 146.

At 350, the user causes the web page 130 to be re-displayed. For example, by using a mouse to click on a button associated with the user interface 150 or the web page 120, the translator can cause the application to re-display the web page 130, according to one embodiment.

At 450, the web page is re-displayed as a part of the entered localization value being associated with the original value. For example, the web-page-redisplayer 230 uses the key 122, nav.home.title, associated with the web page source 110 to retrieve the stored localization value 146, “Mon titre prefere” that was entered. The web-page-redisplayer 230 re-displays the web page 130 showing the localization value 154, 146, “Mon titre prefere,” instead of the original value 144, “My Preferred Title.”

At 360 and 460, the methods end.

One or more of the displayed web page 120, the user interface 150 and the re-displayed web page 130 are a part of the same application, according to one embodiment. Thus, the user perform localization repeatedly using embodiments described at least in the context of flowcharts 300, 400, among other places, without involving the time consuming process of requiring an application team to update a repository and to test values associated with the repository. For example, the user could cause the cursor to move over the localized element 132 associated with the re-displayed web page 130 causing the user interface 150 to be displayed again. Continuing the example, the entry field 152 will include the current stored localized value 146, which in this illustration is “Mon titre prefere.” The user could type in second localization for the title, such as “Mon titre prefere 2,” into the entry field 152 resulting in “Mon titre prefere 2” being stored in the stored localized value 146 and causing “Mon titre prefere 2” being displayed instead of “Mon titre prefere” as the localized element 132 on the re-displayed web page 130. According to one embodiment, the user can perform localization repeatedly during the same user session of the application without exiting the application.

### CONCLUSION

Although many of the embodiments are described with respect to a user that performs in context web page localization being a translator, various embodiments are well suited for other types of users such as non-technical English majors. Although many of the embodiments are described with respect to non-technical people performing in context web page localization, various embodiments are well suited to technical people performing in context web page localization. For example, the translators or the English majors may be technical or non-technical. In another example, the users that perform in context web page localization may be application developers or application testers.

Although many of the embodiments are described with respect to the original value being in English, various embodiments are well suited to the original value being in any language. Although many of the embodiments are described with respect to the entered localization value being in a different language than the original value, various embodiments are well suited to the original value and the localization value being in the same language. For example, the original value may be obtained from a pseudo translation that was obtained from a centralized localization memory, as described herein. In this case, the user interface 150 may display the pseudo translation and a default value. More specifically, assume that the default value is “My Preferred Title” and the centralized localization memory provided “Mon titre prefere” as a pseudo translation. The user interface 150 may display both “My Preferred Title” as the default and “Mon titre prefer” as the pseudo translation. The user may enter a localization value, such as “Mon titre prefere 2.”

Various embodiments have been described in various combinations. However, any two or more embodiments may be combined. Further, any embodiment may be used separately from any other embodiments.

Example embodiments of the subject matter are thus described. Although various embodiments of the subject matter have been described in a language specific to structural features and/or methodological acts, it is to be understood that the appended claims are not necessarily limited to the specific features or acts described above. Rather, the specific features and acts described above are disclosed as example forms of implementing the claims.

What is claimed is:

1. A method of in context web page localization, the method comprising:
causing a web page to be displayed;
selecting a displayed element of the web page;
entering a localization value for the selected element; and
causing the web page to be re-displayed showing the entered localization value instead of an original value associated with the element, wherein the localization value is received by an application, which displays the web page, receives the entered localization value and re-displays the web page.

2. The method as recited by claim 1, wherein the method further comprises:
selecting the displayed element of the re-displayed web page;
entering a second localization value for the selected element of the re-displayed web page;
causing the web page to be re-displayed again showing the second localization value in place of the first localization value.

3. The method as recited by claim 1, wherein the selecting of the displayed element of the web page further comprises:
entering the localization value for the selected element into a user interface that is displayed in response to the selecting of the displayed element.

4. The method as recited by claim 3, wherein the entering of the localization value for the selected element into the user interface further comprises:
entering the localization value for the selected element into the user interface that is a part of the application.

5. The method as recited by claim 1, wherein the method further comprises:
entering a second localization value that is not displayed as a part of a second element displayed on the web page.

6. The method as recited by claim 5, wherein the method further comprises:
selecting the second element displayed on the web page, wherein the second element provides a handle for entering the second localization value without displaying the second localization value.

7. An apparatus for in context web page localization, the apparatus comprising:
an in-context-web-page-localization-mode-selected-element-receiver configured for receiving information describing an element, with an associated original value, displayed on a web page;
an in-context-web-page-localization-mode-localized-value-receiver configured for receiving a localization value entered into a user interface that is a part of an application that provides the web page; and
an in-context-web-page-localization-mode-web-page-re-displayer configured for re-displaying the web page showing the element as a part of associating the localization value with the original value.

8. The apparatus of claim 7, wherein the web page is displayed and the web page is re-displayed while the application is executed in in-context-web-page-localization-mode that enables associating the localization value with the original value.

9. The apparatus of claim 7, wherein the original value and the localization value are invisible values that are not displayed.

10. The apparatus of claim 7, in-context-web-page-localization-mode-web-page-re-displayer is configured for displaying the received localization value instead of the original value as a part of showing the element.

11. The apparatus of claim 7, wherein,
the in-context-web-page-localization-mode-selected-element-receiver is configured for receiving information describing the element that has been selected a second time;
the in-context-web-page-localization-mode-localized-value-receiver is configured for receiving a second localization value entered into the user interface; and
the in-context-web-page-localization-mode-web-page-re-displayer is configured for re-displaying the web page again as a part of replacing the first localization value with the second localization value.

12. The apparatus of claim 7, wherein the application uses a key associated with web page source code to access the original value as a part of displaying the web page and as a part of associating the entered localization value with the original value.

13. A computer-usable medium having computer-readable program code stored thereon for causing a computer system to perform a method of in-context web page localization, the method comprising
receiving information describing a selected displayed element of a web page;
receiving an entered localization value for the element at an application that provides the web page;
associating the entered localization value with an original value of the element; and
re-displaying the web page showing the element as a part of the associating of the entered localization value with the original value, wherein the entered localization value is received by the application, which performs the displaying of the web page, the receiving of the entered localization value and the re-displaying of the web page.

14. The computer-usable medium of claim 13, wherein the computer-readable program code embodied therein causes a computer system to perform the method, and wherein the method further comprises:
enabling the selection of the element for the purpose of receiving the localization value in response to detecting that the application is executed in in-context-web-page-localization-mode.

15. The computer-usable medium of claim 13, wherein the computer-readable program code embodied therein causes a computer system to perform the method, and wherein the re-displaying of the web page further comprises:
re-displaying the web page showing the element, wherein the entered localization value is displayed as a part of the element on the re-displayed web page.

16. The computer-usable medium of claim 13, wherein the computer-readable program code embodied therein causes a computer system to perform the method, and wherein the receiving of the information describing the selected displayed element of the web page further comprises:
receiving information describing a handle for accessing the original value, which is an invisible value that is not displayed as a part of displaying the element.

17. The computer-usable medium of claim 13, wherein the computer-readable program code embodied therein causes a computer system to perform the method, and wherein the re-displaying of the web page further comprises:
using a key associated with web page source code to access the original value as a part of displaying the web page and as a part of associating the entered localization value with the original value.

18. The computer-usable medium of claim 13, wherein the computer-readable program code embodied therein causes a computer system to perform the method, and wherein the method further comprises:
receiving information indicating that the element shown on the re-displayed web page has been selected;
receiving an entered second localization value for the element shown on the re-displayed web page;
re-displaying the web page again as a part of replacing the first localization value with the entered second localization value.

19. The computer-usable medium of claim 13, wherein the computer-readable program code embodied therein causes a computer system to perform the method, and wherein the receiving of the entered localization value further comprises:
receiving the localization value for the selected displayed element at a user interface that is displayed in response to the receiving of the information describing the selected displayed element.

20. The computer-usable medium of claim 18, wherein the computer-readable program code embodied therein causes a computer system to perform the method, and wherein the receiving 430 of the entered localization value 154 at the user interface 150 further comprises:
receiving the entered localization value at the user interface that is a part of the application.
